(19) United States
(12) Patent Application Publication
(10) Pub. No.: US 2024/0097120 A1
(43) Pub. Date: Mar. 21, 2024

(54) COATED POSITIVE ELECTRODE ACTIVE MATERIAL, POSITIVE ELECTRODE MATERIAL, AND BATTERY

(71) Applicant: Panasonic Intellectual Property Management Co., Ltd., Osaka (JP)

(72) Inventor: TAKUJI TSUJITA, Osaka (JP)

(21) Appl. No.: 18/527,307

(22) Filed: Dec. 3, 2023

Related U.S. Application Data
(63) Continuation of application No. PCT/JP2022/020307, filed on May 16, 2022.

(30) Foreign Application Priority Data
Jun. 11, 2021 (JP) 2021-098357

(51) Int. Cl. H01M 4/36; H01M 4/131; H01M 4/505; H01M 4/525; H01M 10/0562

(52) U.S. Cl. CPC H01M 4/366; H01M 4/131; H01M 4/505; H01M 4/525; H01M 10/0562; H01M 2300/008

(57) ABSTRACT

A coated positive electrode active material includes a positive electrode active material and a coating material that covers at least a part of a surface of the positive electrode active material. The coating material includes Al₂Oₓ where x satisfies 0<x<3. A positive electrode material includes the coated positive electrode active material and a first solid electrolyte material. The first solid electrolyte material includes Li, M, and X. M is at least one selected from the group consisting of metal elements and metalloid elements other than Li. X is at least one selected from the group consisting of F, Cl, Br, and I.

### BACKGROUND

### 1. Technical Field

The present disclosure relates to a coated positive electrode active material, a positive electrode material, and a battery.

### 2. Description of the Related Art

International Publication No. 2019/146216 discloses a battery that includes a halide, an electrode active material, and a coating material disposed on the surface of the electrode active material.

Japanese Unexamined Patent Application Publication No. 2017-054614 discloses a negative electrode active material that includes a coating disposed on the surface thereof, the coating being composed of an aluminum oxide.

Japanese Unexamined Patent Application Publication No. 2015-185290 discloses a solid-state battery that includes active material particles and a metal layer disposed on the surfaces of the active material particles, the metal layer having an apparent average thickness of 0.05 μm or more.

### SUMMARY

One non-limiting and exemplary embodiment provides a positive electrode active material that may improve the cycle characteristics of a battery.

In one general aspect, the techniques disclosed here feature a coated positive electrode active material including a positive electrode active material and a coating material that covers at least a part of a surface of the positive electrode active material, in which the coating material includes Al₂Oₓ where x satisfies 0<x<3.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view of a positive electrode material according to Embodiment 2, schematically illustrating the structure of the positive electrode material;

FIG. 2 is a cross-sectional view of a battery according to Embodiment 3, schematically illustrating the structure of the battery;

FIG. 3 is a diagram schematically illustrating a pressure-molding die used for determining the ionic conductivity of a solid electrolyte material;

FIG. 4 illustrates peaks that belong to Al2p in X-ray photoelectron spectra of the surfaces of coated positive electrode active materials prepared in Example 1 and Comparative Example 2 and Al₂O₃, which are measured by X-ray photoelectron spectroscopy; and

FIG. 5 includes graphs of charge-discharge curves of batteries prepared in Examples 1 to 3 and Comparative Examples 1 and 2, which illustrate the initial charge-discharge characteristics of the batteries.

### DETAILED DESCRIPTIONS

### Underlying Knowledge Forming Basis of the Present Disclosure

There has been room for improvement of the cycle characteristics of solid-state lithium-ion secondary batteries known in the related art in terms of the oxidative decomposition of a solid electrolyte. In order to address the above issue, a method in which the surface of a positive electrode active material is covered with an oxide is reported. However, an oxide that covers the surface of a positive electrode active material may inhibit the conduction of lithium ions and electrons and cause capacity reduction or the like. Accordingly, batteries that include a positive electrode active material the surface of which is covered with a coating material are not likely to have consistent battery characteristics, such as cycle characteristics. Although a method in which the surface of an active material is covered with a metal is also reported, it is not possible to limit the oxidative decomposition of a solid electrolyte to a sufficient degree.

### Summary of Aspects of the Present Disclosure

A coated positive electrode active material according to a first aspect of the present disclosure includes:
a positive electrode active material; and
a coating material that covers at least a part of a surface of the positive electrode active material, wherein
the coating material includes Al₂Oₓ
where x satisfies 0<x<3.

Since at least a part of the surface of the coated positive electrode active material according to the first aspect is covered with a coating material including Al₂Oₓ where x satisfies 0<x<3, the likelihood of the oxidative decomposition of a solid electrolyte occurring when the solid electrolyte is brought into contact with the positive electrode active material in a battery may be reduced with effect. In addition, inhibition of the conduction of lithium ions in the surface of the positive electrode active material may be limited. Thus, the coated positive electrode active material according to the first aspect may effectively limit the oxidative decomposition of a solid electrolyte and an increase in internal resistance and consequently improve the cycle characteristics of a battery.

According to a second aspect of the present disclosure, for example, in the coated positive electrode active material according to the first aspect, the coating material may consist essentially of Al and O, and a full width at half maximum of a peak belonging to Al2p in a spectrum obtained by X-ray photoelectron spectroscopy of a surface of the coated positive electrode active material may be more than 1.80 eV.

The coated positive electrode active material according to the second aspect may improve the cycle characteristics of a battery.

According to a third aspect of the present disclosure, for example, in the coated positive electrode active material according to the first or second aspect, the positive electrode active material may include a material represented by Formula (2):

LiNi_{α}Co_{β}Me_{1-α-β}O₂ (2)
where α and β satisfy 0≤α<1, 0≤β≤1, and 0≤1−α−β≤0.35, and Me represents at least one selected from the group consisting of Al and Mn.

The coated positive electrode active material according to the third aspect may enhance the charge-discharge capacity of a battery.

According to a fourth aspect of the present disclosure, for example, in the coated positive electrode active material according to the third aspect, at least one selected from the group consisting of the following conditions (A) and (B) may be satisfied:
(A) an Al/Ni atom ratio in a surface of the coated positive electrode active material is 2.9 or less; and
(B) an Al/Co atom ratio in a surface of the coated positive electrode active material is 4.6 or less.

The coated positive electrode active material according to the fourth aspect may further improve the cycle characteristics of a battery.

A positive electrode material according to a fifth aspect of the present disclosure includes:
the coated positive electrode active material according to any one of the first to fourth aspects; and
a first solid electrolyte material, wherein
the first solid electrolyte material includes Li, M, and X,
M is at least one selected from the group consisting of metal elements and metalloid elements other than Li, and
X is at least one selected from the group consisting of F, Cl, Br, and I.

The positive electrode material according to the fifth aspect may improve the cycle characteristics of a battery.

A battery according to a sixth aspect of the present disclosure includes: a positive electrode;
a negative electrode; and
a solid electrolyte layer interposed between the positive electrode and the negative electrode, wherein
the positive electrode includes the positive electrode material according to the fifth aspect.

The battery according to the sixth aspect may have improved cycle characteristics.

### Embodiment 1

A coated positive electrode active material according to Embodiment 1 of the present disclosure includes a positive electrode active material and a coating material that covers at least a part of the surface of the positive electrode active material. The coating material includes Al₂Oₓ where x satisfies 0<x<3.

Al₂Oₓ (0<x<3) increases the likelihood of lithium being diffused in the coating material. Furthermore, since the coating material covers at least a part of the surface of the positive electrode active material, conduction of electrons, which causes the decomposition of a solid electrolyte, may be reduced. Consequently, the cycle characteristics of a battery may be improved.

x may satisfy 2≤x<3. In such a case, the likelihood of lithium being diffused in the coating material may be increased. Furthermore, conduction of electrons, which causes the decomposition of a solid electrolyte, may be reduced. Consequently, the cycle characteristics of a battery may be improved.

The presence of Al₂Oₓ (0<x<3) can be confirmed by, for example, determining whether the full width at half maximum of a peak belonging to Al2p in an X-ray photoelectron spectrum obtained by X-ray photoelectron spectroscopy is larger than the full width at half maximum (1.80 eV) of a peak belonging to Al2p in an X-ray photoelectron spectrum obtained by X-ray photoelectron spectroscopy of Al₂O₃. This is presumably because various Al atoms having different valences are present.

The coating material may consist essentially of Al and O and the full width at half maximum of a peak belonging to Al2p in a spectrum obtained by X-ray photoelectron spectroscopy of the surface of the coated positive electrode active material may be more than 1.80 eV.

Note that the expression “the coating material consists essentially of Al and O” means that the ratio (i.e., molar fraction) of the total amount of substance of Al and O to the total amount of substance of all the elements constituting the coating material is 90% or more. For example, the above ratio may be 95% or more. The proportion of the total amount of substance of Al and O may be 98% or more or 99% or more.

The coating material may include elements that inevitably enter the coating material. Examples of such elements include Li, which may be diffused in the coating material as a result of the repeated use of a lithium-ion secondary battery that includes the coated positive electrode active material according to the present disclosure.

The coating material may be composed of Al and O.

The coating material may include Al₂Oₓ (0<x<3) as a principal component. The term “principal component” used herein refers to a component the content of which is the highest in terms of mass proportion.

The above-described structure may further improve the cycle characteristics of a battery.

The coating material may be composed only of Al₂Oₓ (0<x<3).

The coating material may cover 30% or more, 60% or more, or 90% or more of the surface of the positive electrode active material. The coating material may cover substantially the entirety of the surface of the positive electrode active material.

The coating material may be brought into direct contact with the surface of the positive electrode active material.

The thickness of the coating material may be, for example, 100 nm or less or 10 nm or less. The coating material may be formed on the surface of the positive electrode active material in an island-like manner. The coating material may be used in a trace amount close to the detection limit. When the presence of Al₂Oₓ (0<x<3) in the positive electrode is confirmed, it is considered that Al₂Oₓ (0<x<3) is deposited on the positive electrode active material in a certain amount and the improvement of cycle characteristics can be confirmed accordingly. In particular, when the thickness of the coating material is 10 nm or less, the capacity reduction may be limited without inhibiting conduction of lithium. The thickness of the coating material may be 5 nm or less. When the thickness of the coating material is 5 nm or less, the capacity reduction may be further limited.

In the case where the thickness of the coating material is 5 nm or less, when the surface of the coated positive electrode active material is analyzed by X-ray photoelectron spectroscopy, a peak corresponding to an element derived from the positive electrode active material can be also observed as well as a peak derived from the coating material.

The thickness of the coating material may be 1 nm or more. When the thickness of the coating material is 1 nm or more, the surface of the positive electrode active material can be covered with the coating material in a sufficient manner and the decomposition of a solid electrolyte may be reduced.

The method for measuring the thickness of the coating material is not limited. For example, the thickness of the coating material may be directly measured with a transmission electron microscope.

The coated positive electrode active material according to Embodiment 1 of the present disclosure may satisfy at least one selected from the group consisting of conditions (A) and (B) below.
(A) The Al/Ni atom ratio in the surface of the coated positive electrode active material is 2.9 or less.
(B) The Al/Co atom ratio in the surface of the coated positive electrode active material is 4.6 or less.

The Al/Ni atom ratio and the Al/Co atom ratio can be calculated by, for example, X-ray photoelectron spectroscopy.

### Method for Covering Surface of Positive Electrode Active Material

The coating material can be formed on the surface of the positive electrode active material by the following method. It should be noted that the following description does not limit the method for preparing the coated positive electrode active material.

The coating material is formed by, for example, depositing Al on the surface of the positive electrode active material by a gas-phase method, such as sputtering or electron beam vapor deposition, in an oxygen-containing atmosphere in which the oxygen content is controlled. The coating material may also be formed by depositing Al on the surface of the positive electrode active material by the above-described gas-phase method, a plating method, or the like and subsequently heating the resulting coating film in an oxygen atmosphere.

The positive electrode active material may include a lithium transition metal complex oxide. The transition metal included in the lithium transition metal complex oxide may be at least one selected from the group consisting of nickel (Ni), cobalt (Co), manganese (Mn), iron (Fe), copper (Cu), chromium (Cr), titanium (Ti), niobium (Nb), zirconium (Zr), vanadium (V), tantalum (Ta), and molybdenum (Mo).

The lithium transition metal complex oxide can be produced by, for example, mixing a lithium compound with a compound including a transition metal which is prepared by coprecipitation or the like and heat-treating the resulting mixture under predetermined conditions. The lithium transition metal complex oxide commonly forms secondary particles, which are formed as a result of aggregation of a plurality of primary particles. The average size (D50) of particles of the lithium transition metal complex oxide is, for example, 1 μm or more and 20 μm or less. Note that the term “average particle size (D50)” used herein refers to the particle size (volume-average particle size) at which a cumulative volume reaches 50% in a volume-basis particle size distribution measured by laser diffraction scattering.

The lithium transition metal complex oxide may include a metal other than transition metals. The metal other than transition metals may include at least one selected from the group consisting of aluminum (Al), magnesium (Mg), calcium (Ca), strontium (Sr), zinc (Zn), and silicon (Si). The above complex oxide may further include, in addition to metals, boron (B) and the like.

In order to increase capacity, the transition metal may include at least one selected from the group consisting of Ni and Co. The lithium transition metal complex oxide may include Ni and at least one selected from the group consisting of Co, Mn, Al, Ti, and Fe. In order to increase capacity and power, in particular, the lithium transition metal complex oxide may include Ni and at least one selected from the group consisting of Co, Mn, and Al and may include Ni, Co, and at least one selected from the group consisting of Mn and Al. In the case where the lithium transition metal complex oxide includes Co in addition to Li and Ni, the likelihood of the phase transition of the complex oxide, which includes Li and Ni, occurring during charge and discharge can be reduced, the stability of the crystal structure can be enhanced, and the cycle characteristics may be readily improved consequently. In the case where the lithium transition metal complex oxide further includes at least one selected from the group consisting of Mn and Al, thermal stability may be enhanced.

In order to improve cycle characteristics and increase power, the lithium transition metal complex oxide included in the positive electrode active material may include a lithium transition metal complex oxide that has a layered rocksalt crystal structure and includes at least one selected from the group consisting of Ni and Co and may include a lithium transition metal complex oxide that has a spinel crystal structure and includes Mn. In order to increase capacity, the lithium transition metal complex oxide may be a complex oxide that has a layered rocksalt crystal structure and includes Ni and a metal other than Ni, wherein the atomic ratio of Ni to the metal other than Ni is 0.3 or more (hereinafter, this complex oxide is also referred to as “nickel-based complex oxide).

The positive electrode active material may have a layered rocksalt crystal structure and a composition represented by Formula (1) below.

LiNi_{α}Me′_{1-α}O₂ (1)
where α satisfies 0≤α<1, and Me′ represents at least one element selected from the group consisting of Co, Mn, Al, Ti, and Fe.

In Formula (1), in the case where a falls within the above range, the effect of Ni to increase capacity and the effect of the element Me′ to enhance stability may be both achieved in a balanced manner.

In Formula (1), a may be 0.5 or more or may be 0.75 or more.

The positive electrode active material may include a material represented by Formula (2) below.

LiNi_{α}Co_{β}Me_{1-α-β}O₂ (2)
where α and β satisfy 0≤α<1, 0≤β≤1, and 0≤1−α−β≤0.35, and Me represents at least one selected from the group consisting of Al and Mn.

### Embodiment 2

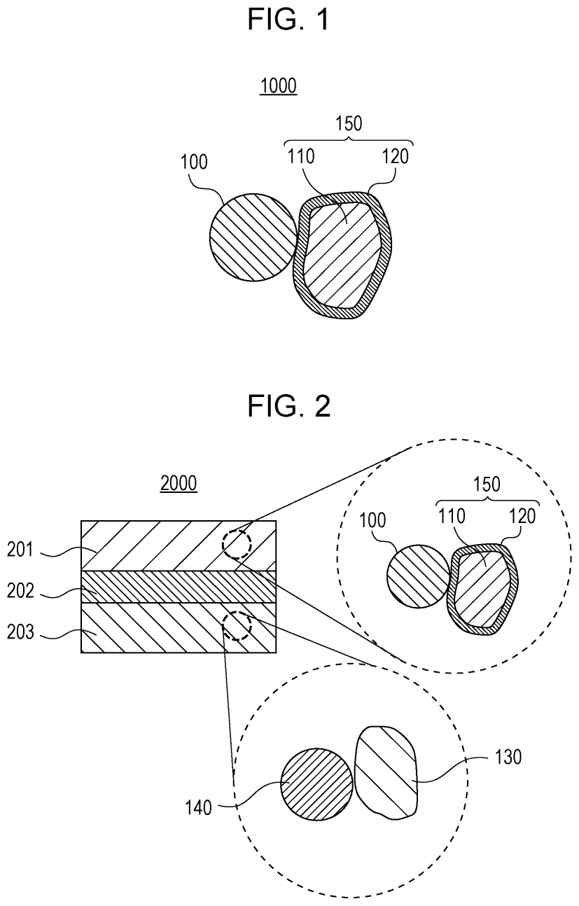

FIG. 1 is a cross-sectional view of a positive electrode material 1000 according to Embodiment 2, schematically illustrating the structure of the positive electrode material 1000. The positive electrode material 1000 according to Embodiment 2 of the present disclosure includes the coated positive electrode active material 150 according to Embodiment 1 and a first solid electrolyte material 100. The coated positive electrode active material 150 includes a positive electrode active material 110 and a coating material 120 that covers at least a part of the surface of the positive electrode active material 110. The first solid electrolyte material 100 includes Li, M, and X, where M represents at least one selected from the group consisting of metal elements and metalloid elements other than Li, and X represents at least one selected from the group consisting of F, Cl, Br, and I.

As described above, the first solid electrolyte material 100 includes a halide solid electrolyte. The first solid electrolyte material 100 may consist essentially of Li, M, and X. The expression “the first solid electrolyte material 100 consists essentially of Li, M, and X” used herein means that the ratio (i.e., molar fraction) of the total amount of substance of Li, M, and X to the total amount of substance of all the elements constituting the first solid electrolyte material 100 is 90% or more. For example, the above ratio (i.e., molar fraction) may be 95% or more. The first solid electrolyte material 100 may be composed only of Li, M, and X. The first solid electrolyte material 100 does not necessarily include sulfur.

In order to enhance ionic conductivity, M may include at least one element selected from the group consisting of the Group 1 elements, the Group 2 elements, the Group 3 elements, the Group 4 elements, and the lanthanoid elements.

M may also include the Group 5 elements, the Group 12 elements, the Group 13 elements, and the Group 14 elements.

Examples of the Group 1 elements include Na, K, Rb, and Cs. Examples of the Group 2 elements include Mg, Ca, Sr, and Ba. Examples of the Group 3 elements include Sc and Y. Examples of the Group 4 elements include Ti, Zr, and Hf. Examples of the lanthanoid elements include La, Ce, Pr, Nd, Sm, Eu, Gd, Tb, Dy, Ho, Er, Tm, Yb, and Lu.

Examples of the Group 5 elements include Nb and Ta. Examples of the Group 12 elements include Zn. Examples of the Group 13 elements include Al, Ga, and In. Examples of the Group 14 elements include Sn.

In order to further enhance ionic conductivity, M may include at least one element selected from the group consisting of Na, K, Mg, Ca, Sr, Ba, Sc, Y, Zr, Hf, La, Ce, Pr, Nd, Sm, Eu, Gd, Tb, Dy, Ho, Er, Tm, Yb, and Lu.

In order to further enhance ionic conductivity, M may include at least one element selected from the group consisting of Mg, Ca, Sr, Y, Sm, Gd, Dy, and Hf.

In order to further enhance ionic conductivity, X may include at least one element selected from the group consisting of Br, Cl, and I.

In order to further enhance ionic conductivity, X may include Br, Cl, and I.

The first solid electrolyte material 100 may be Li₃YX₆. The first solid electrolyte material 100 may be Li₃YBr₆. The first solid electrolyte material 100 may be Li₃YBrₓ₁Cl₆₋ₓ₁ where x1 satisfies 0≤x1<6. The first solid electrolyte material 100 may be Li₃YBrₓ₂Cl_{y2}I_{6-x2-y2} where x2 and y2 satisfy 0≤x2, 0≤y2, and 0≤x2+y2≤6.

The first solid electrolyte material 100 may be Li₃YBr₆, Li₃YBr₂Cl₄, or Li₃YBr₂Cl₂I₂.

The first solid electrolyte material 100 may further include a sulfide solid electrolyte, an oxide solid electrolyte, a polymeric solid electrolyte, or a complex hydride solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, Li₁₀GeP₂S₁₂, and Li₆PS₅Cl. LiX′, Li₂O, MOq, LipM′Oq, and the like may be added to the above sulfide solid electrolytes, where X′ represents at least one selected from the group consisting of F, Cl, Br, and I, M′ represents at least one selected from the group consisting of P, Si, Ge, B, Al, Ga, In, Fe, and Zn, and p and q are integers independent from each other.

Examples of the oxide solid electrolyte include NASICON-type solid electrolytes, such as LiTi₂(PO₄)₃ and element substitution products thereof; perovskite-type solid electrolytes, such as (LaLi)TiO₃; LISICON-type solid electrolytes, such as Li₁₄ZnGe₄O₁₆, Li₄SiO₄, LiGeO₄, and element substitution products thereof; garnet-type solid electrolytes, such as Li₇La₃Zr₂O₁₂ and element substitution products thereof; Li₃N and H-substitution products thereof; Li₃PO₄ and N-substitution products thereof; and glass and glass ceramics that include a Li—B—O compound, such as LiBO₂ or Li₃BO₃, as a base and Li₂SO₄, Li₂CO₃, or the like added to the base.

The polymeric solid electrolyte may be, for example, a compound formed by the reaction of a high-molecular-weight compound with a lithium salt. The high-molecular-weight compound may have an ethylene oxide structure. Since a polymeric solid electrolyte having an ethylene oxide structure is capable of containing a large amount of lithium salt, ionic conductivity may be further enhanced. Examples of the lithium salt include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), and LiC(SO₂CF₃)₃. Only one lithium salt selected from the above lithium salts may be used alone. Alternatively, two or more lithium salts selected from the above lithium salts may be used in a mixture.

Examples of the complex hydride solid electrolyte include LiBH₄—LiI and LiBH₄—P₂S₅.

The shape of the first solid electrolyte material 100 is not limited and may be, for example, acicular, spherical, or spheroidal. For example, the shape of the first solid electrolyte material 100 may be particulate.

In the case where, for example, the shape of the first solid electrolyte material 100 is particulate (e.g., spherical), the median diameter of the first solid electrolyte material 100 may be 100 μm or less. In the case where the median diameter of the first solid electrolyte material 100 is 100 μm or less, the coated positive electrode active material 150 and the first solid electrolyte material 100 can be dispersed in the positive electrode material 1000 in a suitable manner and, consequently, the charge-discharge characteristics of a battery including the positive electrode material 1000 may be enhanced.

The median diameter of the first solid electrolyte material 100 may be 10 μm or less. In such a case, the coated positive electrode active material 150 and the first solid electrolyte material 100 can be dispersed in the positive electrode material 1000 in a further suitable manner.

The first solid electrolyte material 100 may have a smaller median diameter than the coated positive electrode active material 150. In such a case, the coated positive electrode active material 150 and the first solid electrolyte material 100 can be dispersed in the positive electrode material 1000 in a further suitable manner.

The median diameter of the coated positive electrode active material 150 may be 0.1 μm or more and 100 μm or less.

When the median diameter of the coated positive electrode active material 150 is 0.1 μm or more, the coated positive electrode active material 150 and the first solid electrolyte material 100 can be dispersed in the positive electrode material 1000 in a suitable manner and, consequently, the charge-discharge characteristics of a battery including the positive electrode material 1000 may be enhanced. When the median diameter of the coated positive electrode active material 150 is 100 μm or less, the rate at which lithium diffuses in the coated positive electrode active material 150 is increased and, consequently, it may become possible to operate a battery including the positive electrode material 1000 at high powers.

The coated positive electrode active material 150 may have a larger median diameter than the first solid electrolyte material 100. In such a case, the coated positive electrode active material 150 and the first solid electrolyte material 100 can be dispersed in the positive electrode material 1000 in a suitable manner.

### Embodiment 3

Embodiment 3 is described below. Note that description of the items described in Embodiment 1 or 2 above is omitted herein.

FIG. 2 is a cross-sectional view of a battery 2000 according to Embodiment 3, schematically illustrating the structure of the battery 2000.

The battery 2000 according to Embodiment 3 includes a positive electrode 201 that includes the positive electrode material 1000 described in Embodiment 2 above, a negative electrode 203, and a solid electrolyte layer 202 interposed between the positive electrode 201 and the negative electrode 203.

The battery 2000 may be a solid-state battery.

Positive Electrode 201

The positive electrode 201 includes a material capable of occluding and releasing a metal ion (e.g., lithium ion). The positive electrode 201 includes a coated positive electrode active material 150 and a first solid electrolyte material 100.

The ratio of the volume of the positive electrode active material 110 included in the positive electrode 201 to the total volume of the positive electrode active material 110 and the first solid electrolyte material 100 included in the positive electrode 201, that is, the volume ratio Vp, may be 0.3 or more and 0.95 or less. When the volume ratio Vp is 0.3 or more, the battery 2000 is likely to have a sufficiently high energy density. When the volume ratio Vp is 0.95 or less, it becomes easier to operate the battery 2000 at high powers.

The thickness of the positive electrode 201 may be 10 μm or more and 500 μm or less.

When the thickness of the positive electrode 201 is 10 μm or more, the battery 2000 may have a sufficiently high energy density. When the thickness of the positive electrode 201 is 500 μm or less, it may become possible to operate the battery 2000 at high powers.

The positive electrode 201 may include a binder. The binder is used to enhance the integrity of the materials constituting the positive electrode 201. Examples of the binder include polyvinylidene fluoride, polytetrafluoroethylene, polyethylene, polypropylene, an aramid resin, polyamide, polyimide, polyamide imide, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyether, polyethersulfone, hexafluoro polypropylene, a styrene butadiene rubber, and carboxymethyl cellulose. The binder may be a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. Alternatively, a mixture of two or more selected from the above materials may be used as a binder.

The positive electrode 201 may include a conductant agent. The conductant agent is used to enhance electron conductivity. Examples of the conductant agent include graphite materials, such as natural graphite and artificial graphite; carbon black materials, such as acetylene black and Ketjenblack; conductive fibers, such as a carbon fiber and a metal fiber; carbon fluorides; metal powders, such as an aluminum powder; conductive whiskers, such as a zinc oxide whisker and a potassium titanate whisker; conductive metal oxides, such as titanium oxide; and conducting polymers, such as polyaniline, polypyrrole, and polythiophene. The use of a carbon conductant agent may reduce the costs. The above conductant agents may be used alone or in combination of two or more.

The positive electrode 201 may further include a positive electrode current collector.

The positive electrode current collector may be, for example, a metal foil. Examples of the metal constituting the positive electrode current collector include aluminum, titanium, an alloy including the above metal elements, and a stainless steel. The thickness of the positive electrode current collector is, for example, but not limited to, 3 μm or more and 50 μm or less. The metal foil may be coated with carbon or the like.

Negative Electrode 203

The negative electrode 203 includes a material capable of occluding and releasing a metal ion (e.g., lithium ion). The negative electrode 203 includes, for example, a negative electrode active material. The negative electrode 203 may include a negative electrode active material 130 and a second solid electrolyte material 140.

The negative electrode active material 130 may include a carbon material capable of occluding and releasing a lithium ion. Examples of the carbon material capable of occluding and releasing a lithium ion include graphite materials (e.g., natural graphite and artificial graphite), graphitizable carbon (i.e., soft carbon), and non-graphitizable carbon (i.e., hard carbon). Among these, graphite is desirable because it enhances the charge-discharge stability and has a low irreversible capacity.

The negative electrode active material 130 may include an alloying material. The alloying material is a material that includes at least one metal capable of alloying with lithium. Examples of the alloying material include silicon, tin, indium, a silicon alloy, a tin alloy, an indium alloy, and a silicon compound. The silicon compound may be a composite material that includes a lithium ion conduction phase and silicon particles dispersed in the above phase. The lithium ion conduction phase may be a silicate phase, such as a lithium silicate phase, a silicon oxide phase in which the proportion of silicon dioxide is 95% by mass or more, a carbon phase, or the like.

In the case where a lithium alloy or a lithium-occluding metal is used as a negative electrode active material 130, the negative electrode 203 does not necessarily include the second solid electrolyte material 140 and may be composed only of the negative electrode active material 130.

The negative electrode active material 130 may include a lithium titanium oxide. The lithium titanium oxide may include at least one material selected from Li₄Ti₅O₁₂, Li₇Ti₅O₁₂, and LiTi₂O₄.

As a negative electrode active material 130, the alloying material and the carbon material, or the lithium titanium oxide and the carbon material may be used in combination.

The content of the second solid electrolyte material 140 in the negative electrode 203 may be the same as or different from the content of the negative electrode active material 130 in the negative electrode 203.

The ratio of the volume of the negative electrode active material 130 to the total volume of the negative electrode active material 130 and the second solid electrolyte material 140 in the negative electrode 203, that is, the volume ratio Vn, may be 0.3 or more and 0.95 or less. When the volume ratio Vn is 0.3 or more, the battery 2000 is likely to have a sufficiently high energy density. When the volume ratio Vn is 0.95 or less, it becomes easier to operate the battery 2000 at high powers.

The second solid electrolyte material 140 may be a material having the same composition as the above first solid electrolyte material 100 and may be a material having a composition different from that of the above first solid electrolyte material 100.

The second solid electrolyte material 140 may be a material described above as an example of the first solid electrolyte material 100. The second solid electrolyte material 140 may be a material having the same composition as the first solid electrolyte material 100 and may be a material having a composition different from that of the above first solid electrolyte material 100.

The thickness of the negative electrode 203 may be 10 μm or more and 500 μm or less.

When the thickness of the negative electrode 203 is 10 μm or more, the battery 2000 may have a sufficiently high energy density. When the thickness of the negative electrode 203 is 500 μm or less, it may become possible to operate the battery 2000 at high powers.

The negative electrode 203 may further include a negative electrode current collector. The negative electrode current collector may be composed of the same material as the positive electrode current collector. The thickness of the negative electrode current collector is, for example, but not limited to, 3 to 50 μm. In the case where a lithium alloy or a lithium-occluding metal is used as a negative electrode active material 130, the lithium-occluding alloy may be used as both negative electrode active material and negative electrode current collector.

The negative electrode 203 may include a negative electrode current collector and a negative electrode mixture layer supported on the surface of the negative electrode current collector. The negative electrode mixture layer can be formed by, for example, mixing the negative electrode active material 130 with the second solid electrolyte material 140 to prepare a negative electrode mixture, dispersing the negative electrode mixture in a disperse medium to form a negative electrode slurry, applying the negative electrode slurry onto the surface of the negative electrode current collector, and drying the resulting coating film. The dried coating film may be rolled as needed. The negative electrode mixture layer may be disposed on either one or both of the surfaces of the negative electrode current collector.

The negative electrode mixture may further include a binder, a conductant agent, a thickener, or the like. The binder and conductant agent may be the same as those used for preparing the positive electrode 201.

Solid Electrolyte Layer 202

The solid electrolyte layer 202 is interposed between the positive electrode 201 and the negative electrode 203.

The solid electrolyte layer 202 is a layer including a solid electrolyte material.

As a solid electrolyte material included in the solid electrolyte layer 202, the materials described above as examples of the first and second solid electrolyte materials 100 and 140 may be used. The solid electrolyte layer 202 may include a solid electrolyte material having the same composition as the first solid electrolyte material 100 or the second solid electrolyte material 140. The solid electrolyte layer 202 may be composed of a material different from the first solid electrolyte material 100 or the second solid electrolyte material 140.

The solid electrolyte layer 202 may include two or more selected from the materials described above as examples of the solid electrolyte materials. For example, the solid electrolyte layer may include a halide solid electrolyte and a sulfide solid electrolyte.

The solid electrolyte layer 202 may include first and second electrolyte sublayers. The first electrolyte sublayer may be interposed between the positive electrode 201 and the negative electrode 203, while the second electrolyte sublayer is interposed between the first electrolyte sublayer and the negative electrode 203. The first electrolyte sublayer may include a material having the same composition as the first solid electrolyte material 100. The second electrolyte sublayer may include a material having a composition different from that of the first solid electrolyte material 100. The second electrolyte sublayer may include a material having the same composition as the second solid electrolyte material 140.

The solid electrolyte layer 202 may include a binder as needed. As a binder, the materials described above as examples of the binder included in the positive electrode 201 may be used.

The solid electrolyte layer 202 may be composed of any of the materials described above as examples of the first and second solid electrolyte materials 100 and 140.

The solid electrolyte layer 202 can be formed by, for example, dispersing the solid electrolyte material in a disperse medium to prepare a solid electrolyte slurry, drying the slurry to form a sheet-like body, and transferring the sheet-like body onto the surface of the positive electrode 201 or the negative electrode 203. The solid electrolyte layer 202 can be also formed by applying the solid electrolyte slurry directly onto the surface of the positive electrode 201 or the negative electrode 203 and drying the resulting coating film.

Although methods for forming the positive electrode 201, the negative electrode 203, and the solid electrolyte layer 202 using slurries are described above, the method for producing the battery 2000 is not limited to coating. The battery 2000 according to Embodiment 3 may be produced by, for example, preparing a material for forming the positive electrode, a material for forming the electrolyte layer, and a material for forming the negative electrode and subsequently preparing a multilayer body that includes a positive electrode, an electrolyte layer, and a negative electrode that are stacked on top of one another in this order by a publicly known method. For example, the battery 2000 can be formed by preparing a positive electrode including the positive electrode active material 110, the first solid electrolyte material 100, and a conductant agent, the solid electrolyte layer, and a negative electrode that includes the negative electrode active material 130, the second solid electrolyte material 140, and a conductant agent by powder compaction and bonding the above components to one another.

### EXAMPLES

The present disclosure is specifically described with reference to Examples and Comparative Examples below. It should be noted that the present disclosure is not limited to Examples below.

### Example 1

Preparation of First Solid Electrolyte Material

In an argon atmosphere having a dew point of −80° C. and an oxygen concentration of about 10 ppm (hereinafter, referred to as “dry argon atmosphere”), specific amounts of powders of raw materials, that is, LiBr, YBr₃, LiCl, and YCl₃ were weighed such that the molar ratio between the raw materials was Li:Y:Br:Cl=3:1:2:4. The above materials were mixed with one another in a mortar while being pulverized. The resulting mixture was subjected to a milling treatment for 25 hours at 600 rpm with a planetary ball mill. Hereby, a Li₃YBr₂Cl₄ powder, which is a first solid electrolyte material of Example 1, was prepared.

Evaluation of Composition of First Solid Electrolyte Material

The composition of the first solid electrolyte material prepared in Example 1 was determined by inductively-coupled plasma (ICP) emission spectrometry using an inductively-coupled plasma (ICP) optical emission spectrometer (“iCAP7400” produced by Thermo Fisher Scientific). The results confirmed that the deviation of the Li/Y molar ratio from the ratio between the amounts of components charged was 3% or less. That is, the ratio between the amounts of raw material powders charged into the planetary ball mill and the ratio between the amounts of components of the first solid electrolyte material prepared in Example 1 were substantially the same as each other.

Evaluation of Ionic Conductivity of First Solid Electrolyte Material

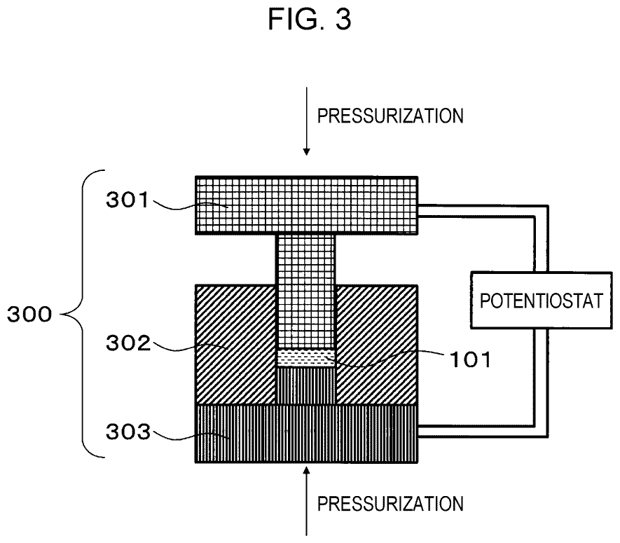

FIG. 3 is a schematic diagram illustrating a pressure-molding die 300 used for determining the ionic conductivity of the first solid electrolyte material.

The pressure-molding die 300 included an upper punch 301, a die 302, and a lower punch 303. The die 302 was composed of insulative polycarbonate. The upper and lower punches 301 and 303 were composed of a conductive stainless steel.

The ionic conductivity of the first solid electrolyte material prepared in Example 1 was measured using the pressure-molding die 300 illustrated in FIG. 3 by the method described below.

In a dry atmosphere having a dew point of −30° C. or less, a powder of the first solid electrolyte material prepared in Example 1 (the solid electrolyte material powder 101 in FIG. 3) was charged into the pressure-molding die 300. In the pressure-molding die 300, a pressure of 300 MPa was applied to the solid electrolyte material of Example 1 with the upper and lower punches 301 and 303.

With the pressure being applied to the solid electrolyte material, the upper and lower punches 301 and 303 were connected to a potentiostat equipped with a frequency response analyzer (“VersaSTAT4” produced by Princeton Applied Research). The upper punch 301 was connected to the working electrode and the potential measuring terminal, while the lower punch 303 was connected to the counter electrode and the reference electrode. The impedance of the first solid electrolyte material was determined at room temperature. The ionic conductivity of the first solid electrolyte material was determined by electrochemical impedance spectroscopy.

The ionic conductivity of the first solid electrolyte material of Example 1 at 22° C. was 1.5×10⁻³ S/cm. The first solid electrolyte material was used also in Examples 2 and 3 and Comparative Examples 1 and 2.

Preparation of Coated Positive Electrode Active Material

The positive electrode active material used was complex oxide particles that had a layered rocksalt structure and a composition of LiNi_{0.5}Co_{0.3}Mn_{0.2}O₂ (average particle size (D50): 4.4 μm; hereinafter, this complex oxide is referred to as “NCM”).

A method for covering the surface of the positive electrode active material with Al₂Oₓ (0<x<3) serving as a coating material is described below. Note that the coating method is not limited to this.

While the flow rate of oxygen was controlled, the coating material was deposited on the positive electrode active material by sputtering using Al as a target with the target thickness being set to 5 nm. The positive electrode active material was sealed in a cage covered with a metal mesh, and the cage was rotated such that the coating material was deposited on the positive electrode active material while the positive electrode active material was consistently stirred.

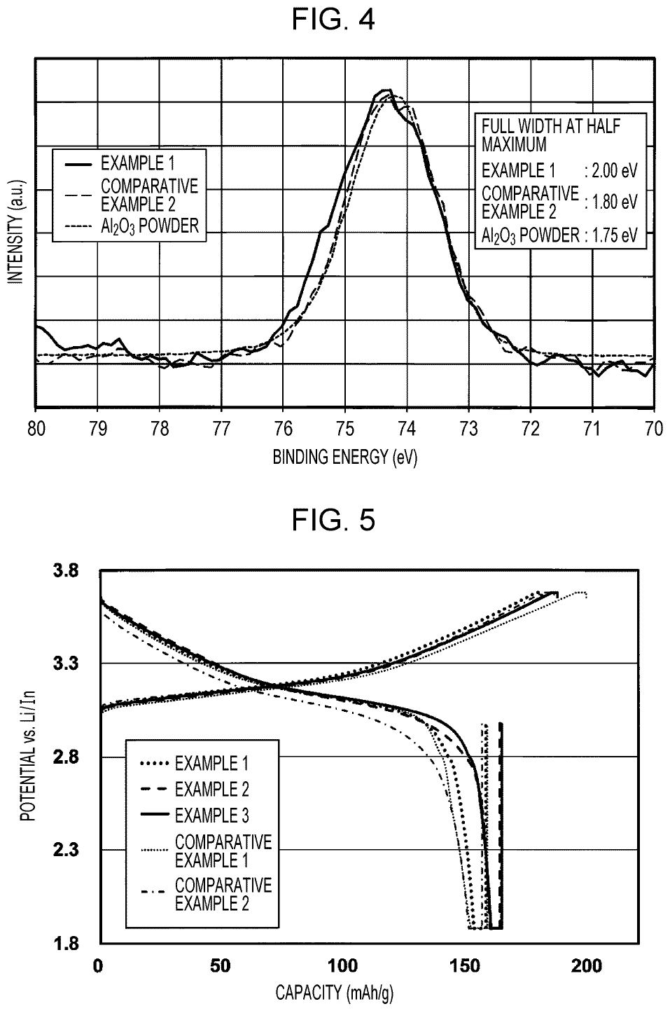

A surface analysis was conducted by X-ray photoelectron spectroscopy. FIG. 4 illustrates peaks that belong to Al2p in X-ray photoelectron spectra of the surface of the coated positive electrode active material of Example 1 and an Al₂O₃ powder, which were measured by X-ray photoelectron spectroscopy. The full width at half maximum of the peak belonging to Al2p in Example 1 was large compared with the peak belonging to Al2p in the spectrum of an Al₂O₃ powder. This confirms a change in the valence of Al. Thus, the formation of a coating including Al₂Oₓ (0<x<3) on the surface of the positive electrode active material was confirmed.

The results of the surface analysis conducted by X-ray photoelectron spectroscopy also confirmed that the Al/Ni atom ratio and Al/Co atom ratio in the surface of the coated positive electrode active material of Example 1 were 2.89 and 4.56, respectively. The above atomic ratios were calculated from the peak intensities and sensitivity coefficients of the above elements. The surface analysis was conducted using an X-ray photoelectron spectroscopy system (“Quantera” produced by ULVAC-PHI, Incorporated.).

Preparation of Positive Electrode Mixture

In a dry argon atmosphere, specific amounts of the first solid electrolyte material, the coated positive electrode active material, and a vapor-grown carbon fiber (“VGCF” produced by Showa Denko K. K.) used as a conductant agent were weighed such that the weight ratio between the above materials was 34:64:2. The above materials were mixed with one another in an agate mortar to form a positive electrode mixture. Note that “VGCF” is a registered trademark of Showa Denko K. K.

Preparation of Battery

In an insulative cylinder, 13.1 mg of the positive electrode mixture, 80 mg of the first solid electrolyte material, and 80 mg of a solid electrolyte material Li₆PS₅Cl (produced by MSE) were stacked on top of one another. The above materials were pressure-molded at a pressure of 720 MPa into a multilayer body including a positive electrode and a solid electrolyte layer. On the surface of the solid electrolyte layer which was opposite to the surface on which the positive electrode was disposed, metal In (thickness: 200 μm), metal Li (thickness: 300 μm), and metal In (thickness: 200 μm) were stacked on top of one another. Subsequently, pressure molding was performed at a pressure of 80 MPa. Hereby, a multilayer body including a positive electrode, a solid electrolyte layer, and a negative electrode was prepared. Then, a stainless steel current collector was attached to the upper and lower ends of the multilayer body, that is, the positive and negative electrodes. A current collection lead was attached to each of the current collectors. Finally, the inside of the insulative cylinder was isolated from the outside atmosphere and hermetically sealed using an insulative ferrule. Hereby, a battery of Example 1 was prepared.

Charge-Discharge Test

The battery prepared in Example 1 was subjected to the following charge-discharge test.

The battery was placed in a thermostat kept at 25° C.

The battery was charged at a constant current of 130 μA to a potential of 3.68 V with respect to Li/In and subsequently charged at a constant voltage. The current at which constant-voltage charging was to be finished was set to 26 μA.

The battery was then discharged at a constant current of 130 μA to a potential of 1.88 V with respect to Li/In and subsequently discharged at a constant voltage. The current at which constant-voltage discharging was to be finished was set to 26 μA.

The battery was subjected to a cycle test with the above charge and discharge being considered as one cycle. Table 1 lists the 1st-cycle discharge capacity and the 50th-cycle discharge retention of the battery prepared in Example 1.

Note that the 50th-cycle discharge retention is the ratio of the discharge capacity measured in the 50th cycle to the discharge capacity measured in the 1st cycle. The 50th-cycle discharge retention was more than 100% because resistance was reduced and capacity was increased in first few cycles.

FIG. 5 includes a charge-discharge curve illustrating the initial charge-discharge characteristics of the battery prepared in Example 1.

### Example 2

A battery of Example 2 was prepared as in the preparation of the battery of Example 1, except that, in the preparation of a positive electrode active material the surface of which was covered with a coating material, the target thickness was set to 1 nm.

A charge-discharge test was conducted as in Example 1. Table 1 lists the 1st-cycle discharge capacity and the 50th-cycle discharge retention of the battery prepared in Example 2. FIG. 5 includes a charge-discharge curve illustrating the initial charge-discharge characteristics of the battery prepared in Example 2.

### Example 3

A battery of Example 3 was prepared as in the preparation of the battery of Example 1, except that, in the preparation of a positive electrode active material the surface of which was covered with a coating material, the target thickness was set to 3 nm.

A charge-discharge test was conducted as in Example 1. Table 1 lists the 1st-cycle discharge capacity and the 50th-cycle discharge retention of the battery prepared in Example 3. FIG. 5 includes a charge-discharge curve illustrating the initial charge-discharge characteristics of the battery prepared in Example 3.

### Comparative Example 1

A battery of Comparative Example 1 was prepared as in the preparation of the battery of Example 1, except that the positive electrode mixture of Comparative Example 1 was prepared by weighing specific amounts of NCM used as a positive electrode active material, the first solid electrolyte material, and the conductant agent “VGCF” such that the mass ratio between the above material was 34:64:2 and mixing the materials with one another in a mortar. That is, the positive electrode active material used in Comparative Example 1 was not covered with a coating material.

A charge-discharge test was conducted as in Example 1. Table 1 lists the 1st-cycle discharge capacity and the 50th-cycle discharge retention of the battery prepared in Comparative Example 1. FIG. 5 includes a charge-discharge curve illustrating the initial charge-discharge characteristics of the battery prepared in Comparative Example 1.

The 50th-cycle discharge retention of the battery prepared in Comparative Example 1 was low compared with Examples 1 to 3. This is because, since the positive electrode material did not include a coating material, resistance was increased as a result of oxidative decomposition of a solid electrolyte and discharge capacity was reduced accordingly. As illustrated in FIG. 5, the battery prepared in Comparative Example 1 had a larger initial charge capacity than the batteries prepared in Examples 1 to 3. This is because oxidative decomposition of a solid electrolyte occurred during the initial charging of the battery of Comparative Example 1 and the apparent charge capacity was increased due to the oxidation reaction.

### Comparative Example 2

While the flow rate of oxygen was controlled, the coating material was deposited on the positive electrode active material NCM by sputtering using Al as a target with the target thickness being set to 2 nm.

The surface analysis of the coated positive electrode active material prepared in Comparative Example 2 was conducted by X-ray photoelectron spectroscopy. FIG. 4 illustrates peaks that belong to Al2p in X-ray photoelectron spectra of the surface of the coated positive electrode active material of Comparative Example 2 and an Al₂O₃ powder, which were measured by X-ray photoelectron spectroscopy. The full width at half maximum of the peak belonging to Al2p was substantially the same as the full width at half maximum of the peak belonging to Al2p in the spectrum of an Al₂O₃ powder. Thus, the formation of a coating composed of Al₂O₃ on the surface of the positive electrode active material of Comparative Example 2 was confirmed.

A battery of Comparative Example 2 was prepared as in the preparation of the battery of Example 1.

A charge-discharge test was conducted as in Example 1. Table 1 lists the 1st-cycle discharge capacity and the 50th-cycle discharge retention of the battery prepared in Comparative Example 2. FIG. 5 includes a charge-discharge curve illustrating the initial charge-discharge characteristics of the battery prepared in Comparative Example 2.

The 1st-cycle discharge capacity and the 50th-cycle discharge retention of the battery prepared in Comparative Example 2 were low compared with Examples 1 to 3. Moreover, as illustrated in FIG. 5, the battery of Comparative Example 2 had a lower charge capacity and a lower discharge voltage than the battery of Comparative Example 1. The above results indicate that, although the occurrence of oxidative decomposition of a solid electrolyte during charging was reduced by the coating compared with Comparative Example 1, resistance was increased disadvantageously due to the Al₂O₃ coating.

TABLE 1

| | 1st-Cycle | 50th-Cycle |
|---|---|---|
| | discharge | discharge |
| | capacity | retention |
| | [mAh/g] | [%] |
| Example 1 | 157.6 | 101.2 |
| Example 2 | 163.1 | 97.4 |
| Example 3 | 164.1 | 100.9 |
| Comparative Example 1 | 158.1 | 90.0 |
| Comparative Example 2 | 156.0 | 90.9 |

In Example 1, the 50th-cycle discharge retention was higher than in Example 2. This is presumably because the surface of the positive electrode active material was covered in a sufficient manner and the oxidative decomposition of a solid electrolyte was reduced to a sufficient degree.

The solid-state battery according to the present disclosure may be suitably used as, for example, a power source for mobile devices, such as a smart phone, a power unit for vehicles, such as an electric vehicle, a power source for automobile-installed equipment, or a device capable of storing natural energy, such as solar energy.

What is claimed is:

1. A coated positive electrode active material comprising:
a positive electrode active material; and
a coating material that covers at least a part of a surface of the positive electrode active material, wherein
the coating material includes Al₂Oₓ
where x satisfies 0<x<3.

2. The coated positive electrode active material according to claim 1, wherein
the coating material consists essentially of Al and O, and
a full width at half maximum of a peak belonging to Al2p in a spectrum obtained by X-ray photoelectron spectroscopy of a surface of the coated positive electrode active material is more than 1.80 eV.

3. The coated positive electrode active material according to claim 1, wherein
the positive electrode active material includes a material represented by Formula (2):
LiNi_{α}Co_{β}Me_{1-α-β}O₂ (2)
where α and β satisfy 0≤α<1, 0≤β≤1, and 0≤1−α−β≤0.35, and Me represents at least one selected from the group consisting of Al and Mn.

4. The coated positive electrode active material according to claim 3, wherein
at least one selected from the group consisting of the following conditions (A) and (B) is satisfied:
(A) an Al/Ni atom ratio in a surface of the coated positive electrode active material is 2.9 or less; and
(B) an Al/Co atom ratio in a surface of the coated positive electrode active material is 4.6 or less.

5. A positive electrode material comprising:
the coated positive electrode active material according to claim 1; and
a first solid electrolyte material, wherein
the first solid electrolyte material includes Li, M, and X,
M is at least one selected from the group consisting of metal elements and metalloid elements other than Li, and
X is at least one selected from the group consisting of F, Cl, Br, and I.

6. A battery comprising:
a positive electrode;
a negative electrode; and
a solid electrolyte layer interposed between the positive electrode and the negative electrode, wherein
the positive electrode includes the positive electrode material according to claim 5.
